(19) United States
(12) Patent Application Publication
(10) Pub. No.: US 2024/0184592 A1
(43) Pub. Date: Jun. 6, 2024

(54) LOCATION AND TIME BOUND DIGITAL CONTAINER ACCESS CONTROL

(71) Applicant: Evrbit GmbH, Köln (DE)

(72) Inventors: Axel Hado Steinkuhle, Cologne (DE); Silke Kachtik, Cologne (DE); Arkadiusz Juszczyk, Brühl (DE); Anselm Weidmann, Cologne (DE)

(21) Appl. No.: 18/076,263

(22) Filed: Dec. 6, 2022

(51) Int. Cl. G06F 9/445

(52) U.S. Cl. CPC G06F 9/445

(57) ABSTRACT

Methods, systems, and apparatus, including computer programs encoded on computer storage media, for location and time bound digital container access control. One of the methods includes obtaining first data specifying a first geographic space in which a software widget operates; obtaining second data specifying a first timeframe during which the software widget is accessible; performing, on a mobile device of a user, a function of the software widget comprising receiving from a user, after the user has obtained a copy of the software widget when in the first geographic space and during the first timeframe, new location data specifying a second geographic space in which the software widget operates and new timeframe data specifying a second timeframe during which the software widget is accessible; and performing the function within the second geographic space and during the second timeframe.

### BACKGROUND

### Technical Field

This specification relates to location and time bound digital container access control.

### Background

A geofence is a virtual perimeter for a geographic area. Geofencing can involve sending of notifications when a location-based device enters the geofence.

### SUMMARY

This specification describes technologies for location and time bound digital container access control.

In general, one innovative aspect of the subject matter described in this specification can be embodied in methods that include the actions of: obtaining first data specifying a first geographic space in which a software widget operates; obtaining second data specifying a first timeframe during which the software widget is accessible; performing, on a mobile device of a user, a function of the software widget comprising receiving from a user, after the user has obtained a copy of the software widget when in the first geographic space and during the first timeframe, new location data specifying a second geographic space in which the software widget operates and new timeframe data specifying a second timeframe during which the software widget is accessible; and performing the function within the second geographic space and during the second timeframe.

A software widget is a relatively simple and easy-to-use software application or component made for one or more different software platforms. A desk accessory or applet is an example of a software widget as a simple, stand-alone user interface. Software widgets can be considered to be transient and auxiliary applications that don't monopolize the user's attention.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. Digital assets can be contextualized by both time and location. Users can use a digital container system to manipulate the accessibility of data by time and location conditions. Users can search for digital content, by location, to find digital content that was initially obtained at a certain location. A user can create a personal digital landscape by adding useful digital assets into the personal landscape of the user. Ad hoc location based communities can be created and managed and used for distribution of digital assets. A user can copy a digital asset that was initially obtained while at a particular location during a particular timeframe in which the asset was available to a local context and use the digital asset even after the digital asset is no longer generally available from its original source. Embodiments described in this specification can provide a user with increased control over data, including the user's location and/or time-relevant data. Other advantages are described below.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a system for smart digital containers.

FIG. 2 illustrates a system for drop containers.

FIG. 3 is a flowchart of an example of a method for location and time bound digital container access control, according to some implementations of the present disclosure.

FIG. 4A illustrates a first example data model for a drop container system.

FIG. 4B is a diagram that illustrates other drop behaviors.

FIG. 5 illustrates a system for drop container use in different use cases and contexts.

FIG. 6 is a diagram that illustrates characteristics of drop containers.

FIGS. 7-15 illustrate drop application user interfaces.

FIG. 16 illustrates a second example data model for a drop container system.

FIG. 17 is a block diagram of an example system illustrating drop types as feature collections and drop containers as drop type instances.

FIG. 18 is a swim lane diagram of an example process for user, client device, and server interaction related to a drop container.

FIG. 19 is a swim lane diagram of an example process for creating a local copy of a drop container.

FIG. 20 is a swim lane diagram of an example process for interacting with a local copy of a drop container.

FIG. 21 is a block diagram of an example computer system used to provide computational functionalities associated with described algorithms, methods, functions, processes, flows, and procedures described in the present disclosure.

Like reference numbers and designations in the various drawings indicate like elements.

### DETAILED DESCRIPTION

The combination of digital and analog worlds can facilitate information gathering, collaboration, user support, entertainment and the conduct of transactions. Previously, digital and analog worlds have been treated separately. However, a smart container system described herein can change how people interact with their environment. The smart container system merges the digital and analog worlds into one interactive platform. The interactive platform uses smart containers that are referred to as drop containers (or simply “drops”) that are accessible in the physical world at a certain place and in a certain timeframe.

Drop containers are software widgets that can blend digital content with constraints of the real world such as location and time-based constraints. Accordingly, a landscape of drop containers can provide an infrastructure of content constrained by, for example, space and time. The solution described herein provides a bookmarking and storage system utilizing place and time of the user for collections of digital applications, enabling users to create a personal, private, and sharable computation platform. Accordingly, the interactive platform provides a universal tool for specific solutions, creating impact, by being more local, by using latest location-based technology for seamless interaction, and by providing the right information and functionality at the right place at the right time.

Any digital content can be distributed in the drop containers. A benefit of the container system is that digital assets in containers are contextualized by time, place, and in some cases by a personal profile of the user. Drop containers can be transferred to a local instance of the users device, where a local copy of the drop container can be used and adapted independently of the original. Digital assets in the local copy can then be executed or accessed again in the user's local context, even when the original template version no longer exists.

Drop containers can be used for various different types of use cases. For instance, in a first example, a user can receive as a drop from another user an item of digital content while at a certain location, such as Chicago, IL. The user can interact with the content in a time window after receipt in that location of Chicago. Based on the user's interactions, or based on a request from the user, the drop content can be stored in a user context that is specific to the user, enabling the user to later find the drop content, such as by searching for content related to the location of Chicago. The user can retrieve the content and re-invoke (e.g., re-drop the content) and interact with the content again, even if or when the original content shared by the other user has been deleted. In some cases, the user re-invokes the content when back at that same location of Chicago. In other cases, the user re-invokes the content at a location other than Chicago (but as mentioned, may find the content again by filtering for content originally received in Chicago).

As a second example, users who are in proximity to a digital billboard (e.g., at an event) can be delivered an application that is associated with the digital billboard. The users can be delivered the application when they are in front of the digital billboard, for example. The application can be delivered to users in response to the system detecting, for example, when at least a certain number of user devices are in front of the billboard. The delivered application can enable the users to perform certain functionalities, such as voting in polls related to the event. Voting results from users using the application during the event, in proximity to the digital billboard, can be displayed on the digital billboard.

As another example, content of a container can adapt based on a location into which it is dropped. “Dropping” a container can include enabling a container to be accessible at a particular location and a subsequent obtaining of the container at that location. As an example, a train schedule application included in a drop container can provide schedule information for trains arriving or departing a certain station if the container is dropped to a user when the user is at that location. If the container is dropped while the user is at another train station, the schedule application can be configured to provide schedule information for that station. Many other uses cases are possible, as described in more detail below, including for events, teams, logistics, private organizations, communities, and many others.

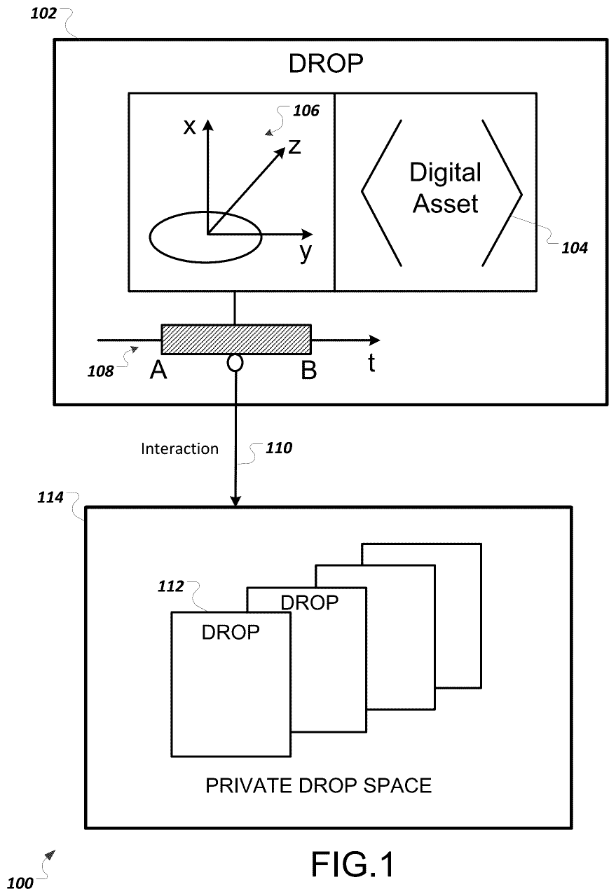

FIG. 1 illustrates a system 100 for smart digital containers. As described above, the system 100 can support use of temporary containers that are distributable to mobile devices at a specific time and place for control by the receiving user with the option to apply location and time bound functionalities. These temporary containers can be transferred to a local instance of the users device and profile as a local copy, where the local copy can be used and automatically adapted independently of the original temporary container. A digital asset in the local copy of container can then be executed again in the user's local context, even when the original temporary container no longer exists.

In further detail, a drop container 102 includes a digital asset 104, geo coordinates 106 that define both a geographic location where the drop container 102 can be accessed, and concurrently time constraint(s) 108 that define a timeframe for when the drop container 102 is accessible. The digital asset 104 can be any type of digital content or application. The drop container 102 can also include access rules for the drop container 102, that indicate, for example, whether the drop container 102 is accessible publicly or only to specific user(s).

The geo coordinates 106 can include, for example, coordinates that represent X, Y, Z locations along with a radius that together define an area in which the drop container 102 can be accessed (or obtained). The time constraints 108 can define a lifetime for accessibility of the drop container 102 at the defined location. For example, the drop container 102 can be currently available but can have an upcoming expiration time, such as, for example, one hour, one month, one week from now. As another example, the expiration time can be dynamic, such as 14 days after a last interaction with the digital asset. As yet another example, the time constraints 108 can define a future time period of availability (e.g., access for the drop container 102 can be schedulable for a future time period, such as during a future event).

In response to a user interaction by a particular user with the digital asset 104 (e.g. as represented by an interaction arrow 110), a copy 112 of the drop container 102 can be made available in a local context 114 of the user. The copying of the digital asset 104 to the copy 112 in the local context 114 is a decoupling of the digital asset 104 from the drop container 102 to the local context 114 of the user. The user, for example, can initially obtain access to the drop container 102 according to the time and space constraints indicated by the time constraints 108 and geo coordinates 106, respectively, but through interaction with the digital asset 104 or through an explicit request, can copy the drop container 102 to enable access to the copy 112 at other times and/or in other places, even after the original drop container 102 is deleted and no longer available. In some cases, the copy 112 can be configured to have new time and space constraints that are different from corresponding constraints of the drop container 102.

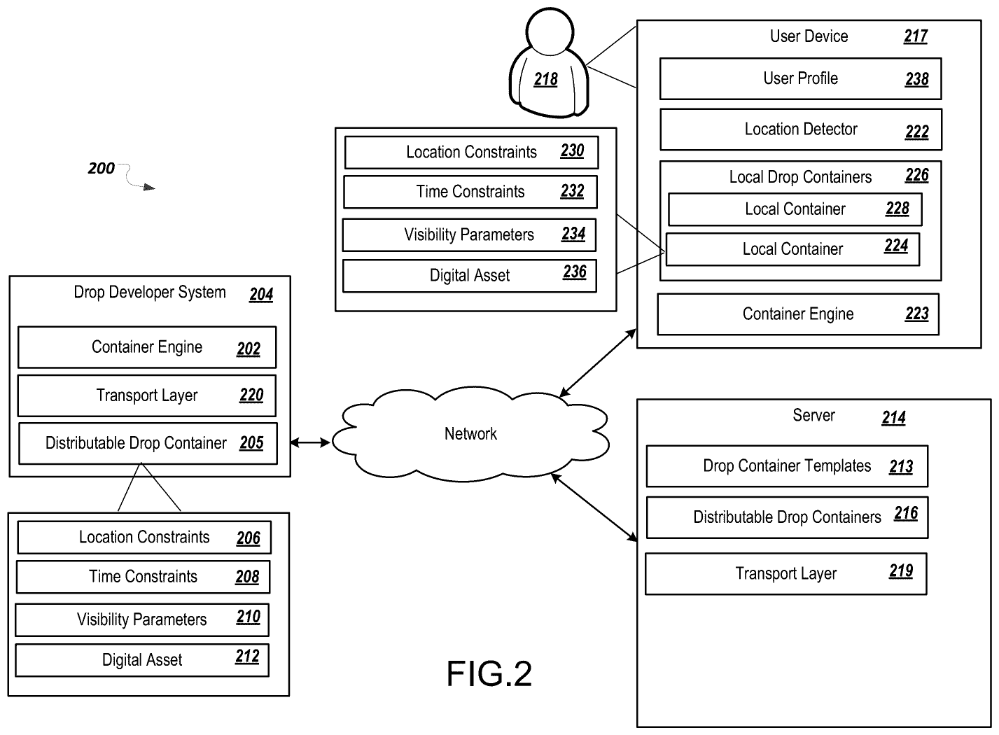

FIG. 2 illustrates a system 200 for drop containers. The system 200 can support mechanisms for using temporary drop containers that are distributable at a specific time and place for access control of digital entities with the option to apply location and time bound functionalities.

A drop developer/creator can use a container engine 202 of a drop developer system 204 to create and define a distributable drop container 205. The distributable drop container 205 can include location constraints 206, time constraints 208, visibility parameters 210, and a digital asset 212. The location constraints 206 can define a location at which the digital asset 212 of the distributable drop container 205 is accessible. The time constraints 208 can define a timeframe during which the digital asset 212 is accessible, and the timeframe can represent a current time window, a scheduled future time window, or a repeated time window. The visibility parameters 210 can define accessibility to specified users, the drop container author, to groups, or to the public. The distributable drop container 205 can include other information, such as information that indicates whether a user can copy the drop container to a local context of the user, as described below.

In some cases, the distributable drop container 205 is created based on a drop container template retrieved from a drop container templates library 213 published by a server 214. In some cases, the distributable drop container 205 is provided to the server 214 for storage in a distributable drop containers repository 216, for distribution to a user device 217 of a user 218 using a transport layer 219. In other cases, the drop developer system 204, or another device executing on behalf of the drop developer, can distribute the distributable drop container 205, to the user device 217. The device associated with the drop developer can include a transport layer 220 that can distribute the distributable drop container 205 to the user device 217, such as in a peer-to-peer arrangement.

The user device 217 includes a location detector 222 that can detect when the user device 217 is at the location of the distributable drop container 205 specified by the location constraints 206. A container engine 223 can determine that the user device 217 is at the location during a timeframe specified by the location constraints 206. The container engine 202 can notify the user in various ways of the availability of obtaining the distributable drop container 205. The user 218 can request to obtain the distributable drop container 205 and the distributable drop container 205 can be provided to the user device 217 and stored in the user device 217 as a local container 224 in a local drop containers repository 226. The local drop containers repository 226 can include other drop containers, such as a local container 228.

Once copied, the local container 224 can initially include location constraints 230, time constraints 232, visibility parameters 234, and a digital asset 236 that correspond to the location constraints 202, the time constraints 208, the visibility parameters 210, and the digital asset 212, respectively. The user can interact with the local container 224, independently of the distributable drop container 205. If permitted by the drop author, the user can change constraints or parameters of the local container 224 without affecting corresponding constraints or parameters of the distributable drop container 205. Additionally, the drop developer may, at some point, remove availability of the distributable drop container 205 and/or the timeframe availability of the distributable drop container 205 specified by the time constraints 208 may expire. The user 218 may still use the local container 224, even after the distributable drop container 205 is no longer available.

The user device 217 (and/or the server 214) can store a user profile 238. For some types of drop containers, the behavior of the digital asset 236 included in the local container 224 can change based on information in the user profile 238.

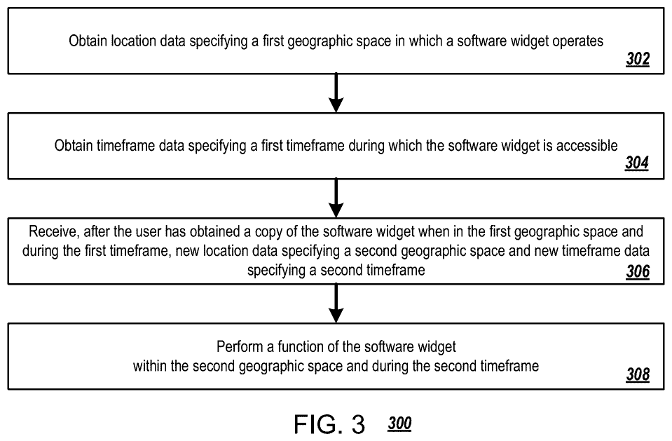

FIG. 3 is a flowchart of an example of a method 300 for location and time bound digital container access control, according to some implementations of the present disclosure. For example, the system 200 can be used to perform the method 300. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, location data specifying a first geographic space in which a software widget operates is obtained. The software widget can be a drop container, as described above.

At 304, timeframe data specifying a first timeframe during which the software widget is accessible is obtained.

At 306, a function of the software widget is performed, performing, on a mobile device of a user, where the function includes receiving from the user, after the user has obtained a copy of the software widget when in the first geographic space and during the first timeframe, new location data specifying a second geographic space in which the software widget operates and new timeframe data specifying a second timeframe during which the software widget is accessible.

At 308, the function is performed within the second geographic space and during the second timeframe.

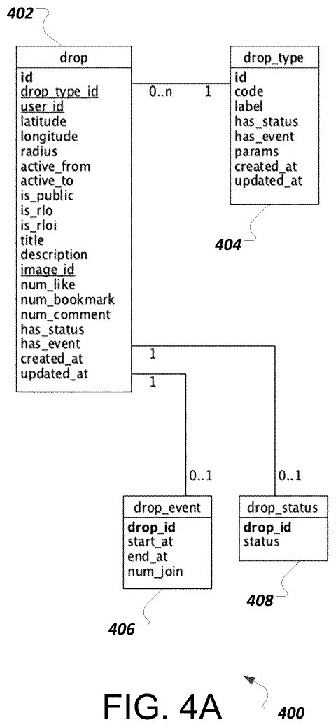

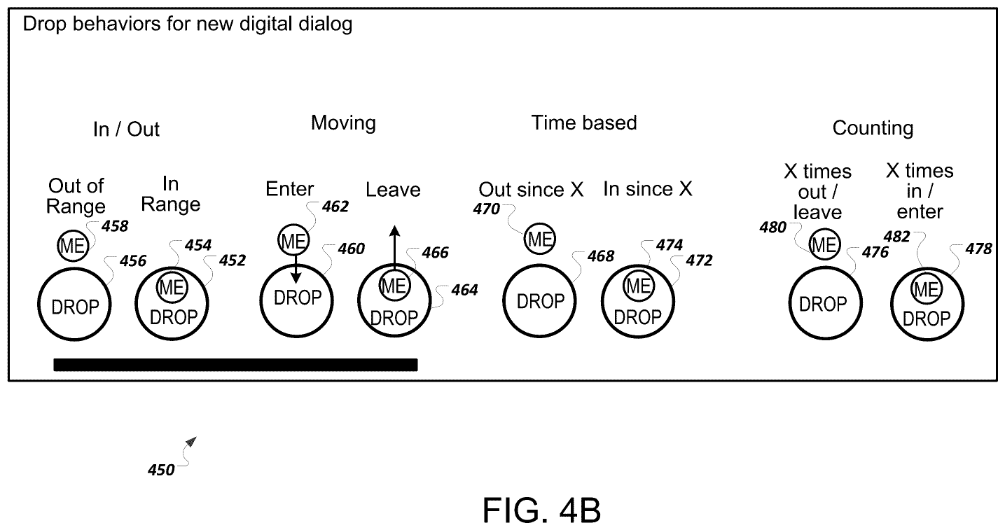

FIG. 4A illustrates a first example data model 400 for a drop container system. A drop entity 402 represents a drop container. The drop entity 402 can include various technical and other types of fields. For example, an id field can be a primary key of the drop entity and can store a unique (e.g., numeric) identifier of a given drop container. A drop_type_id field can store an identifier of a drop_type entity 404 that is associated with the drop container. The drop_type entity 404 represents categories of drops. A drop_type entity instance can define certain features that are common to drops of that drop type. Other technical information in the drop entity 402 includes a creation timestamp, a timestamp of last update, and a user_id field that stores an identity of a user entity that represents an author or creator of the drop container.

The drop entity 402 includes different space/time information that defines parameters for location and time constraints for a drop container's visibility to users. The timeframe information stored in the drop entity 402 can include an active_from field and an active_to field that define a visibility lifetime for the drop container. Location information can include latitude, longitude, and radius fields. The latitude and longitude values can be geo coordinates rounded to multiples of arc deciseconds, for example. The radius value can be a visibility radius around the location defined by the longitude and latitude, expressed in degrees. The drop location defined by the longitude and latitude can define a center of a drop area for the drop container. When displayed to users, location coordinates can be displayed in degrees, minutes, seconds, tenth of second, rather than float values, to improve user readability.

The drop entity 402 can include other access/visibility information, such as for specifying whether the drop container is visible to the author only (e.g., as a private drop), to specific users (e.g., friends), or to the general public. For example, an is_public field can store a true value if the drop container is publicly accessible and an is_friends field can store a true value if the drop container is visible only to friends of the drop author. An is_rlo field can store a true value if the drop container is only visible for users who are physically in range of the drop container (e.g., according to the location information stored in the instance of the drop entity 402). For example, if is_rlo is false, a map search performed by a user who is out of range may still show the drop container, even if the user has to go to the certain location to obtain (and interact with) the drop container. If is_rlo is true, the user may not even be aware of the existence of the drop container until being at the location (e.g.., a map search performed by a user who is out of range may not include the drop container in the search results). An is_rloi field can be set to true to configure that users must be in range to perform non-owner interactions with the drop container.

The drop entity 402 can include fields that can store information displayed to users who search for or are notified about the drop container. For example, a title field can store a title to be used (e.g., in list views), a description field can store a longer description of the drop container content, and an image field can store a reference to an image that is a main drop image for the drop container.

The drop entity 402 can store various “has” fields that store data indicating whether the drop container has various types of features in addition to general drop container data. For example, a has_event field can store information indicating whether the drop container is associated with a drop_event entity 406 instance. The drop_event entity 406 can represent an event drop that includes a time interval and a participant list. Users can join/leave the participant list until the end of the event interval is reached. A drop owner can remove participants until the drop expires. A has_status field can indicate whether the drop container is associated with a drop_status entity 408 instance. The semantic meaning of a drop status can be dependent on the drop type.

The drop entity 402 can store various social data about a drop container. For example, the drop entity 402 can store information that enables multi-user interaction, a like/favorite count, a comment count, a bookmark count, etc.

FIG. 4B is a diagram 450 that illustrates other drop behaviors. Drop access and/or functionality can be defined with respect to in or out of range detection, entering or leaving detection, time-based rules, or counting rules.

For example, drop functionality can be activated, made available, or modified based on these types of conditions. For instance, functionality of a drop container 452 can be activated or modified in response to a user device 454 being in range of (e.g., within a geographic location defined by) the drop container 452. Similarly, functionality of a drop container 456 can be activated or modified in response to a user device 458 being out of range of the drop container 456. Drop containers can also respond to specific events relating to movement of a user device. For example, a drop container 460 can respond to an “enter” event upon detection of a user device 462 entering the drop location defined by the drop container 460. Similarly, a drop container 464 can respond to a “leave” event upon detection of a user device 466 leaving the drop location defined by the drop container 464.

Other events can be time-based. For example, a drop container 468 can respond to an “out-since” event upon detection of a user device 470 being outside of a drop location defined by the drop container for a certain time period (e.g., after previously having been inside the drop location). As another example, a drop container 472 can respond to an “in-since” event upon detection of a user device 470 being inside the drop location defined by the drop container 472 for a certain amount of time.

Other events can be counting-related. For example, a drop container 476 and/or a drop container 478 can respond to different counting events that occur when a user device 480 or a user device 482 has left or entered a drop location, respectively. For example, a drop application in a drop container can offer a discount after having determined that a user device has entered a drop location for a 10th time.

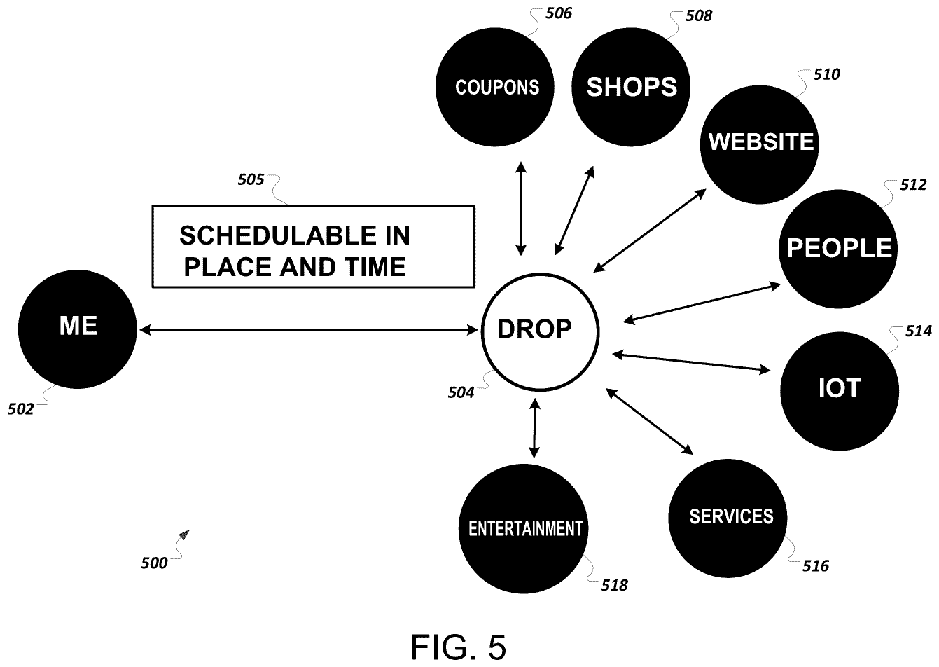

FIG. 5 illustrates a system 500 for drop container use in different use cases and contexts. A user 502 and a corresponding user device of the user 502 can use a drop container 504 in various types of use cases and contexts. As indicated by a note 505, the drop container 504 can be configured, e.g., by the drop container creator or distributer, to be schedulable to be available in a given place and at a given time. The drop container 504 can provide use cases or contexts related to coupons 506, shops 508, websites 510, people/relationships 512, IOT (Internet of Things) 514, services 516, and entertainment 518.

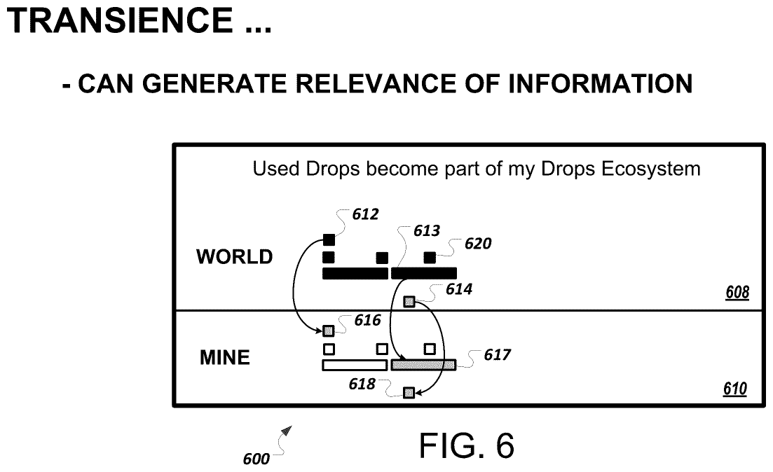

FIG. 6 is a diagram 600 that illustrates characteristics of drop containers. Transience (e.g., time-based availability) of a drop container, at a specific physical location, can generate relevance of information or other assets in the drop container to that time and place. A drop container can: exist for different timeframes (e.g., one day, one week, one month, etc.); be a unique drop; be a repetitive drop (e.g., dropped at an area around a merchant at 3 pm every Thursday); be planned into the future; be for everyone, people on a friend list, or just one user; and disappear when the timeframe of the drop expires.

Additionally, a drop can become a personal drop for a user through interaction. For example, drops that a user interacts with in a global space 608 can become personal drops in a personal space 610, even when those drops are no longer accessible to others in the global space 608. For example, a user has interacted with drops 612, 613, and 614 in the global space 608 and thus corresponding drops 616, 617, and 618, respectively, become available for the user in the personal space 610 of the user. The drop 612 may expire, for example, and no longer be available in the global space 608, but the user can still access the corresponding drop 616 in the personal space 610. A drop in the global space 608, such as a drop 620, that the user does not interact with can disappear from the global space 608 without being copied to the personal space 610 (and is therefore no longer visible or accessible to the user).

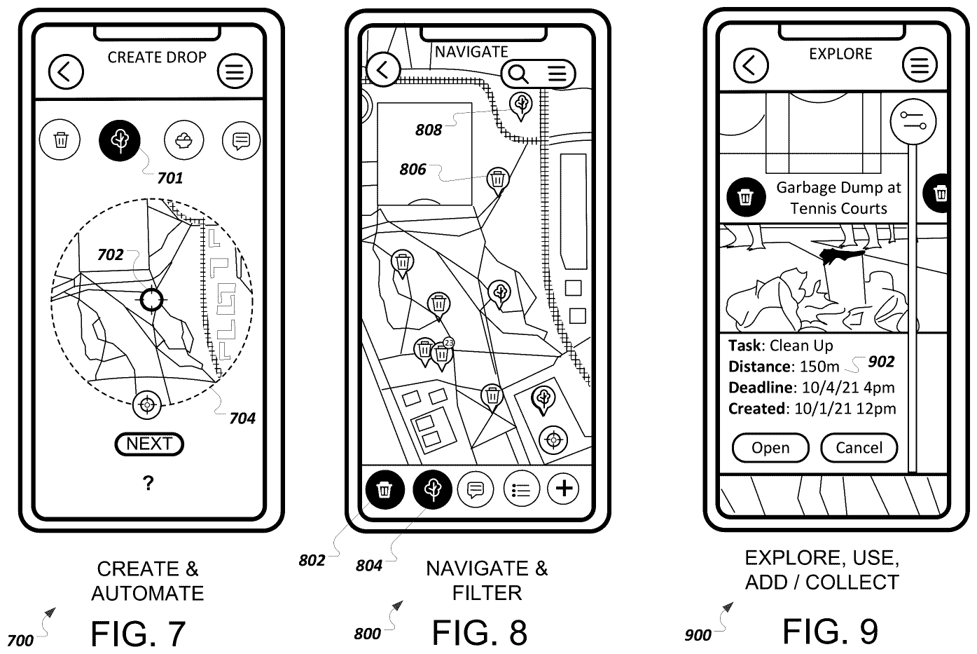

FIGS. 7-15 illustrate drop application user interfaces. A drop container system can provide various types of user interfaces. FIG. 7 illustrates a user interface 700 for creating a drop container. A user can create a drop container by selecting a drop type 701. The drop type 701 can be a predefined drop type that includes functionality for managing nature events for participants of nature events that occur at a particular location, for instance. As described below, a drop type can represent a collection of drop features. A drop creator can also select a location at which the drop container is available by selecting a map location 702 and a radius 704 around the map location 702. The user can also specify time constraints for the drop container. FIG. 8 illustrates a user interface 800 for searching for drop containers. A user can use the user interface 800 to navigate a map to explore availability of existing drop containers at a location displayed in the map, for example. The user can select certain drop type indicators, such as a first drop type indicator 802 and a second drop type indicator 804, to filter the display to only show drop containers of certain drop types. The first drop type indicator 802 can be of a “garbage cleanup event” drop type for managing a garbage clean up event by volunteers at a particular location, for example. Displayed drop type indicators selectable for filtering may be based on a user's personal collection of favorite drop types, for example. Upon selection of a drop type filter, the map can be modified to display locations of drop containers of selected drop type(s). For example, a drop container symbol 806 shows a location of a drop container of the first drop type 802 and a drop container symbol 808 shows a location of a drop container of the second drop type 804. Other drop container symbols show locations of other drop containers of selected drop types. Other search criteria can be specified, such as keywords, tags, etc. The user can navigate the map to a particular location, search for a particular location, etc.

FIG. 9 illustrates a user interface 900 for exploring, using, and collecting drop containers. The user interface 900 displays information for an available drop container. The drop container may be available to the user based on the user being within a radius distance of a drop container location, for example. For instance, a distance value 902 of 150m may be within a specified radius of the drop container. The available drop container may include functionality for participating in and documenting garbage cleanup by volunteers, for example. In general, the user interface 900 can be used to open a particular drop container, interact with the drop container, add comments, likes, and save the drop container to a personal collection, among other interactions.

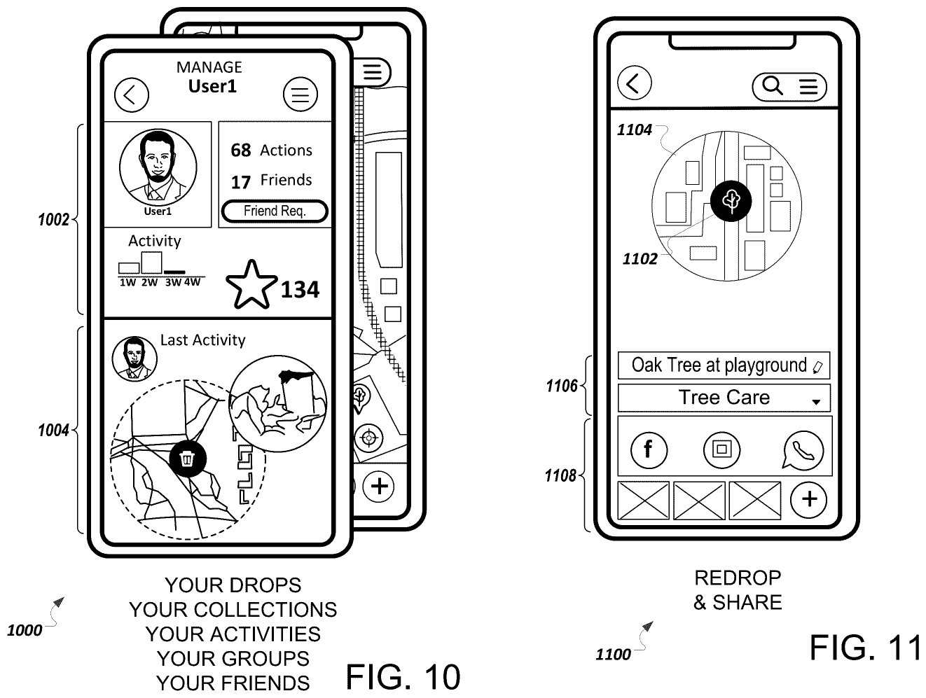

FIG. 10 illustrates a user interface 1000 for managing drop containers. The user can use the user interface to manage saved drop containers, including drop container collections, view information about latest activities, and view and manage information about social groups and relationships related to drop containers. For example, a section 1002 displays summary information about activities and social relationships and a section 1004 displays information about a last activity with a drop container (e.g., the drop container shown to the user in the user interface 900).

FIG. 11 illustrates a user interface 1100 for redropping and sharing drop containers. A drop container can be used as a template to create a new drop container. For example, a user can copy a drop container used for a first event, and “re-drop” the container at a new location (e.g., as shown by a drop container symbol 1102 placed on a map along with a defined radius 1104). A section 1106 can be used to specify a description and other data relevant for the new drop container. Availability information for the new drop container can be shared with other users using a section 1108, for example by using social media and/or other electronic communications.

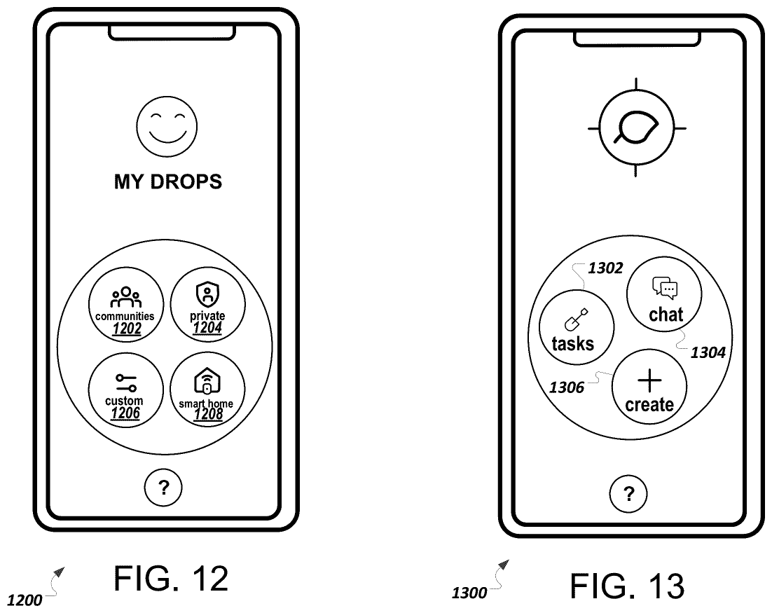

FIGS. 12-15 illustrate presentation and management of drop containers based on various themes. FIG. 12 illustrates a user interface 1200 for accessing personal drop containers according to various categories. For example, the user can view drop containers that are associated with various social communities by selecting a communities icon 1202. The user can access personal (e.g., private) drop containers by selecting a private icon 1204. The user can access custom drop containers (e.g., that the user may also wish to share with other users) by selecting a custom icon 1206. Drop containers relating to a user's home can be accessed by selecting a smart home icon 1208.

FIG. 13 illustrates a user interface 1300 for interacting with drop containers based on an event theme. The user interface 1300 can be a custom application for use by users of an organization to interact with drop containers associated with the organization. For example, the organization may wish users to have access to drop containers for location-based tasks (e.g., tree care) by selecting a tasks icon 1302, for event-based communication by selecting a chat icon 1304, or for new drop container creation (e.g., while at a particular location) by selecting a create icon 1306.

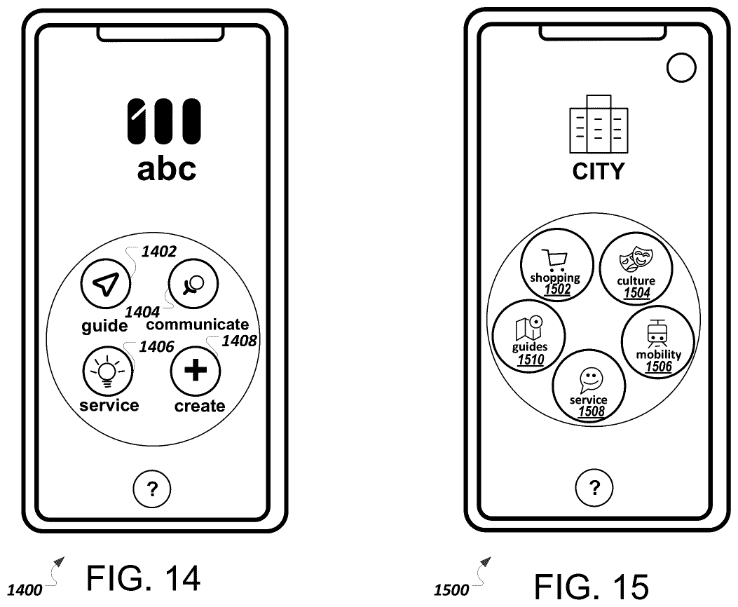

FIG. 14 illustrates a user interface 1400 for theme-based access to drop containers for an organization. An organization (e.g., ABC corp.) may desire to have a private solution for drop containers using a particular theme. When users of the organization access a drop container application, the theme for the organization can be loaded and can be independent from a public drop system interface, for example. The user interface 1400 can organize drop containers available to users of the organization by interactive guide drop containers 1402, communication 1404, and service 1406. A create icon 1408 can be used to create a new drop container by a user of the organization. Organization users may be able to create drop containers for the organization that are of a predefined set of drop types selected or created by the organization, for example.

FIG. 15 illustrates a user interface 1500 for using drop containers in different contexts. The user interface 1500 may be a theme that is loaded to display available drop containers available in a particular city, organized by different categories. A city planner may be involved in creating the theme and selecting categories, for example. Categories of drop containers can include shopping 1502, culture 1504, mobility 1506, service 1508, and guides 1510.

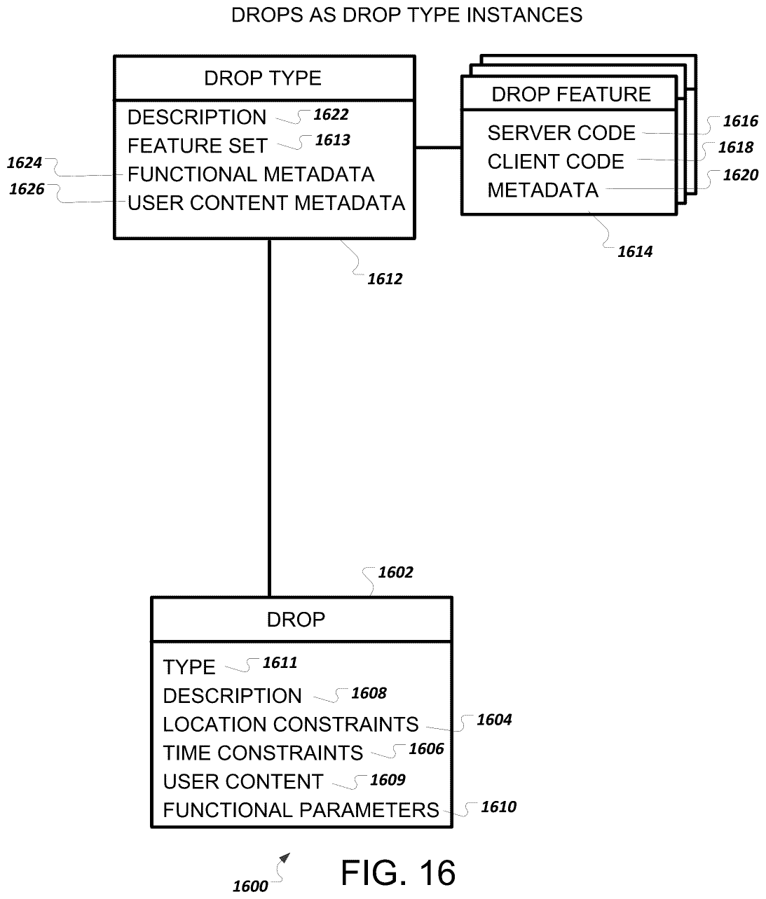

FIG. 16 illustrates a second example data model 1600 for a drop container system. The data model 1600 includes a drop entity 1602. The drop entity 1602 includes location constraints 1604 and time constraints 1606 which are similar to location and time constraints discussed above. A description 1608 can inform the user as to purpose and use of the drop entity 1602. The drop entity 1602 can include user content 1609 associated with or included in the drop by a particular user, for example. The drop entity 1602 can include functional parameters 1610 relating to functionality of the drop container.

Drop functionality can be configured by including a type field 1611 in the drop entity 1602 that refers to an instance of a drop type entity 1612. A feature set field 1613 of the drop type entity 1612 instance can be a collection of one or more drop feature 1614 entities. A drop feature 1614 can include server code 1616, client code 1618 (e.g., to run on a user client device), and metadata 1620. The drop type entity 1612 can include a description 1622 that describes the drop type. The drop type entity 1612 can also include functional metadata 1624 and user content metadata 1626.

The metadata 1620 can include any additional parameters or configuration that are used during execution of the server code 1616 or the client code 1618 that is not hardwired in respective code. The functional metadata 1624 describes the configuration of the feature(s) used in the particular drop type 1612. The user content metadata 1626 is a description of the drop type 1612 and its features for the purpose of client-side display and input form generation. The functional parameters 1610 can include user (e.g., drop author) input specific to the drop type 1612, beyond generic drop data. Not all drop types require all kinds of metadata/parameters.

As an example, suppose a drop type uses a “status” feature. The server code 1616 for the status feature can maintain a status value and push real-time updates of status changes to active clients. The client code 1618 of the status feature can receive and display updates sent by the server. The metadata 1620 of the status feature can define a default configuration for communication channels used for status updates. For instance, example metadata 1620 is shown below:

```
{
  “status_server”: “mqtt.exampleserver.com“,
  “topic_read”: “/drop/{id}/status”,
  “topic_write”: “/drop/{id}/status_write”
}
```

A drop type 1612 that uses the status feature can be, for example, a “to-do” drop type. The functional metadata 1624 for the to-do drop type can define the values that the “status” can have. For instance, example functional metadata 1624 is shown below:

{
“status_values”: [0,1]
}

The user content metadata 1626 for the to-do drop type can describe display labels for those status values, as shown below:

```
{
  ”status_labels”:[“To do”, “Done”],
  ”status_colors”:[“#660000”, “#006600”]
}
```

The functional parameters 1610 for the to-do drop type can be empty in this example since basic drop data can already include the necessary label and description, and client-side code can be configured to display a checkbox as user input.

As another example, a “party” drop type can use an “event” feature. The event feature can include server code 1616 that maintains a list of participants, client code 1618 that allows users to sign up for the event. The metadata 1620 can be empty in this example since feature functionality can be completely defined in feature code.

The functional metadata 1624 for the party drop type that uses the event feature can define restrictions on the number of participants and the duration of the event (e.g., in minutes, as shown below:

```
{
  “max_participants”: 20,
  “max_duration”: 720
}
```

The user content metadata 1626 for the party drop type can include display labels for the restrictions defined in the functional metadata 1624, as shown below:

```
{
  ”participants_exceeded_error”: “The house is full!”,
  ”duration_exceeded_error”: “The party can't be longer than 12 hours!”
}
```

The functional parameters 1610 of a drop 1602 of the party drop type can include feature-specific data as defined by the drop author, such as start_at and end_at information such as described above with respect to FIG. 4A.

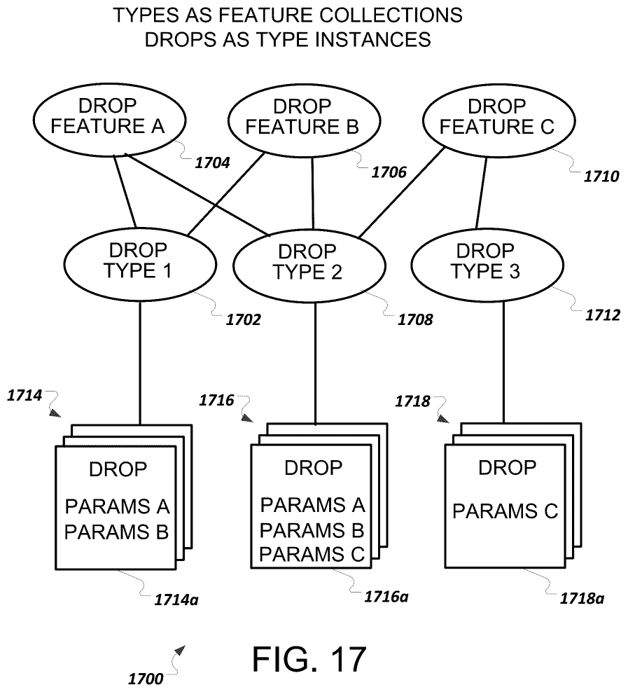

FIG. 17 is a block diagram of an example system 1700 illustrating drop types as feature collections and drop containers as drop type instances. As mentioned, a drop type can be a collection or group of drop features. For example, a first drop type 1702 groups a drop feature A 1704 and a drop feature B 1706, a second drop type 1708 groups the drop feature A 1704, the drop feature B 1706, and a drop feature C 1710, and a third drop type 1712 includes the drop feature C 1710. A drop container can be an instance of a drop type. For example, drop containers 1714 (e.g., including a drop container 1714a) are instances of the first drop type 1702, drop containers 1716 (e.g., including a drop container 1716a) are instances of the second drop type 1708, and drop containers 1718 (e.g., including a drop container 1718a) are instances of the third drop type 1712. Each drop container instance is therefore a concrete implementation of a particular drop type. Each drop container instance can include its own parameter data. For example, the drop container 1714a includes two parameter values, the drop container 1716a includes three parameter values, and the drop container 1718a includes one parameter value.

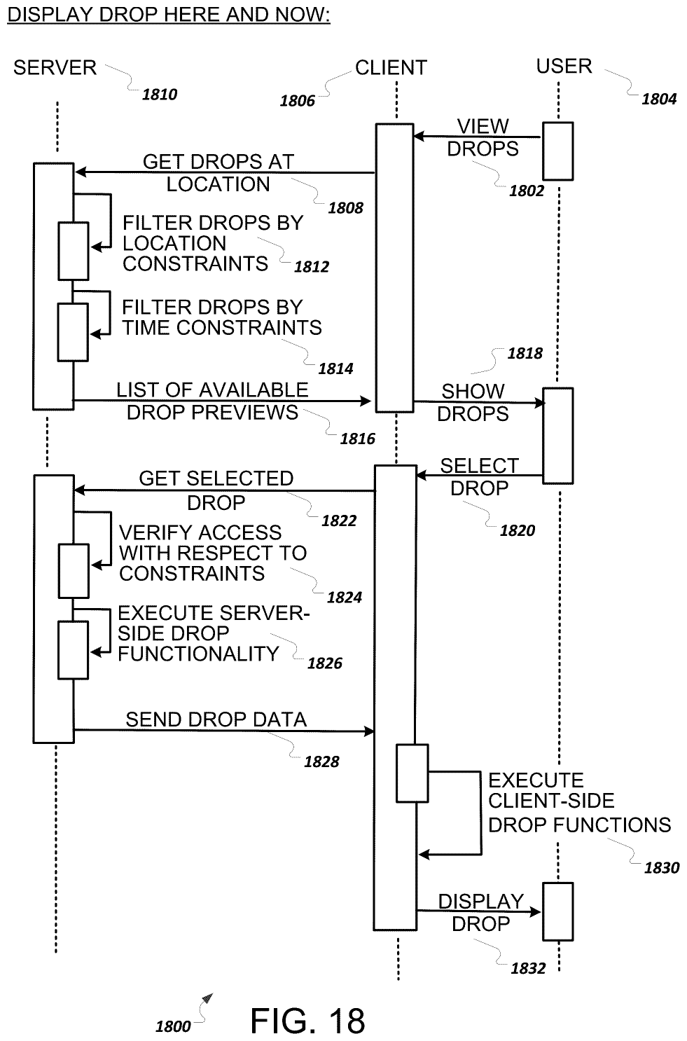

FIG. 18 is a swim lane diagram of an example process 1800 for user, client device, and server interaction related to a drop container. At 1802, a user 1804 interacts with an application on a client device 1806 to request viewing of available drop containers. The request to view drop containers can be a “here and now” request which requests available drops currently available at the user's current location or the request to view drop containers can correspond to a search which may include, for example, future date criteria and/or location criteria specifying a location other than the user's current location.

At 1808, the client device 1806 sends a request to a server 1810 to obtain drop containers available at a location corresponding to the user request. The request sent by the client device 1806 to the server 1810 can also include a time constraint (e.g., the current time or a user-specified time constraint).

At 1812, the server 1810 filters a list of drop containers that the server 1810 may provide by location constraint(s) received from the client device 1806. At 1814, the server 1810 filters the list of drop containers that the server 1810 may provide by time constraints received from the client device 1806.

At 1816, the server 1810 provides a list of available drop containers (e.g., as a preview of available drop containers) to the client device 1806. At 1818, the client device presents the list of available drop containers to the user 1804.

At 1820, the user selects a particular drop container from the presented list of available drop containers. At 1822, the client device 1806 sends a request to the server 1810 to obtain the selected drop container. The request can include the location of the user 1804.

At 1824, the server 1810 verifies that the requested drop is accessible given the current time and the location of the user.

At 1826, the server 1810 can execute server-side drop functionality for the selected drop container. As an example, some drop containers can become available and/or change functionality based on a user-request threshold, such as a particular number of users registering for an event or a particular number of users requesting the drop container while at a particular location. The server-side functionality can be to increment a counter, compare the counter to a threshold, and execute certain functionality based on whether the current counter value exceeds the threshold, for example.

At 1828, the server 1810 sends drop data for the drop container (e.g., client code, metadata) to the client device 1806. At 1830, the client device 1806 can execute client-side functionality. For example, the client code can be configured so that certain code is executed when the drop container is loaded onto the client device 1806. Other client code may be executed in response to user interaction with the drop container, for example. For instance, at 1832, the drop container is displayed to the user 1804, which can enable the user to view drop content and interact with the drop container.

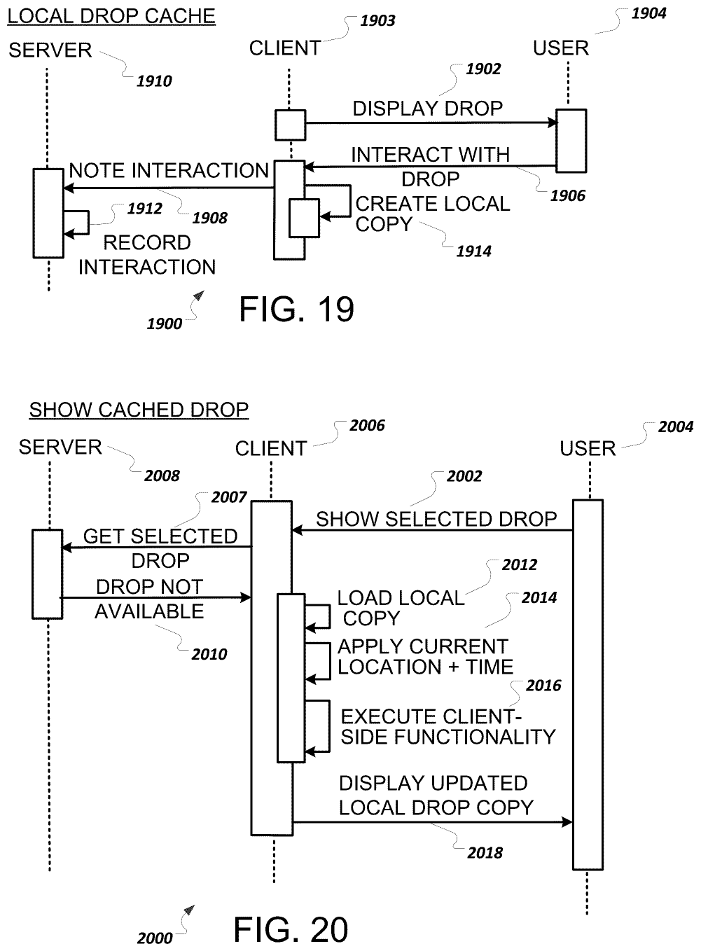

FIG. 19 is a swim lane diagram of an example process 1900 for creating a local copy of a drop container. At 1902, a client device 1903 displays a drop container to a user 1904. At 1906, the user 1904 interacts with the drop container. At 1908, the client device 1903 sends a message to a server 1910 asking the server 1910 to record the interaction. At 1912, the server 1910 records the interaction. At 1914, the client device 1903, in response to the user interaction with the drop container, creates a local copy of the drop container. The local copy can thus be available for the user even when the drop container is no longer available from or published by the server 1910.

FIG. 20 is a swim lane diagram of an example process 2000 for interacting with a local copy of a drop container.

At 2002, a user 2004 selects a drop container presented on a client device 2006. At 2007, the client device 2006 sends a request to a server 2008 to obtain drop data for the selected drop container. At 2010, the server 2008 sends a message to the client device 2006 informing the client device 2006 that the requested drop container is not available on the server 2008.

At 2012, in response to receiving the message from the server 2008 about the unavailability of the drop container on the server 2008, the client device 2006 loads a local copy of the drop container. The local copy may have been saved in response to prior user interaction with the drop container (e.g., as described above with respect to FIG. 19).

At 2014, the client device 2006 applies current location information for the client device 2006 and current time information to the drop container. The current location information correspond to a different location than a location at which the user first obtained the drop container, for example.

At 2016, the client device 2006 executes client-side functionality of the drop container. At 2018, the client device displays content of the drop container to the user 2004, where the displayed content may be updated content as compared to drop content previously displayed to the user 2004.

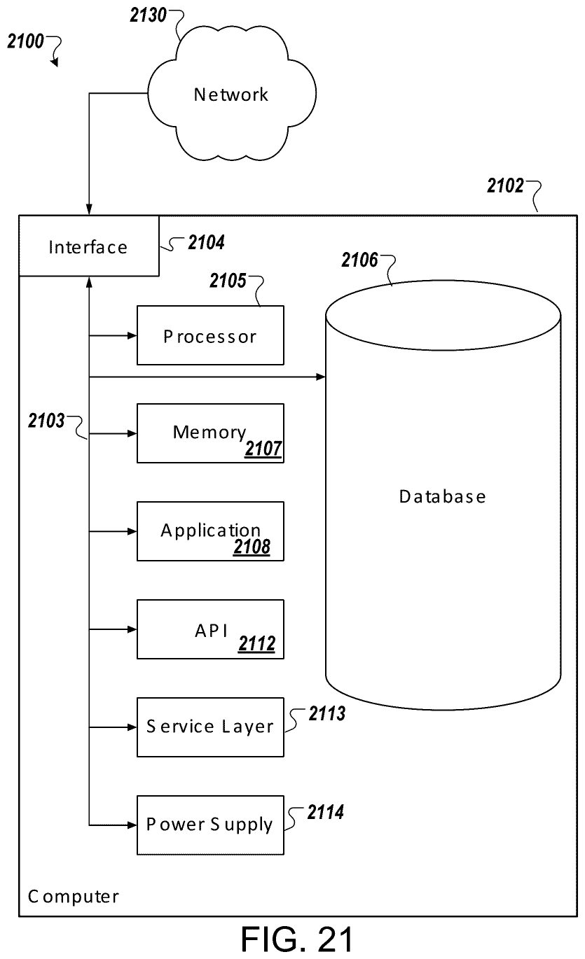

FIG. 21 is a block diagram of an example computer system 2100 used to provide computational functionalities associated with described algorithms, methods, functions, processes, flows, and procedures described in the present disclosure, according to some implementations of the present disclosure. The illustrated computer 2102 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2102 can include input devices such as keypads, keyboards, and touch screens that can accept user information. Also, the computer 2102 can include output devices that can convey information associated with the operation of the computer 2102. The information can include digital data, visual data, audio information, or a combination of information. The information can be presented in a graphical user interface (UI) (or GUI).

The computer 2102 can serve in a role as a client, a network component, a server, a database, a persistency, or components of a computer system for performing the subject matter described in the present disclosure. The illustrated computer 2102 is communicably coupled with a network 2130. In some implementations, one or more components of the computer 2102 can be configured to operate within different environments, including cloud-computing-based environments, local environments, global environments, and combinations of environments.

At a top level, the computer 2102 is an electronic computing device operable to receive, transmit, process, store, and manage data and information associated with the described subject matter. According to some implementations, the computer 2102 can also include, or be communicably coupled with, an application server, an email server, a web server, a caching server, a streaming data server, or a combination of servers.

The computer 2102 can receive requests over network 2130 from a client application (for example, executing on another computer 2102). The computer 2102 can respond to the received requests by processing the received requests using software applications. Requests can also be sent to the computer 2102 from internal users (for example, from a command console), external (or third) parties, automated applications, entities, individuals, systems, and computers.

Each of the components of the computer 2102 can communicate using a system bus 2103. In some implementations, any or all of the components of the computer 2102, including hardware or software components, can interface with each other or the interface 2104 (or a combination of both) over the system bus 2103. Interfaces can use an application programming interface (API) 2112, a service layer 2113, or a combination of the API 2112 and service layer 2113. The API 2112 can include specifications for routines, data structures, and object classes. The API 2112 can be either computer-language independent or dependent. The API 2112 can refer to a complete interface, a single function, or a set of APIs.

The service layer 2113 can provide software services to the computer 2102 and other components (whether illustrated or not) that are communicably coupled to the computer 2102. The functionality of the computer 2102 can be accessible for all service consumers using this service layer. Software services, such as those provided by the service layer 2113, can provide reusable, defined functionalities through a defined interface. For example, the interface can be software written in JAVA, C++, or a language providing data in extensible markup language (XML) format. While illustrated as an integrated component of the computer 2102, in alternative implementations, the API 2112 or the service layer 2113 can be stand-alone components in relation to other components of the computer 2102 and other components communicably coupled to the computer 2102. Moreover, any or all parts of the API 2112 or the service layer 2113 can be implemented as child or sub-modules of another software module, enterprise application, or hardware module without departing from the scope of the present disclosure.

The computer 2102 includes an interface 2104. Although illustrated as a single interface 2104 in FIG. 21, two or more interfaces 2104 can be used according to particular needs, desires, or particular implementations of the computer 2102 and the described functionality. The interface 2104 can be used by the computer 2102 for communicating with other systems that are connected to the network 2130 (whether illustrated or not) in a distributed environment. Generally, the interface 2104 can include, or be implemented using, logic encoded in software or hardware (or a combination of software and hardware) operable to communicate with the network 2130. More specifically, the interface 2104 can include software supporting one or more communication protocols associated with communications. As such, the network 2130 or the interface's hardware can be operable to communicate physical signals within and outside of the illustrated computer 2102.

The computer 2102 includes a processor 2105. Although illustrated as a single processor 2105 in FIG. 21, two or more processors 2105 can be used according to particular needs, desires, or particular implementations of the computer 2102 and the described functionality. Generally, the processor 2105 can execute instructions and can manipulate data to perform the operations of the computer 2102, including operations using algorithms, methods, functions, processes, flows, and procedures as described in the present disclosure.

The computer 2102 also includes a database 2106 that can hold data for the computer 2102 and other components connected to the network 2130 (whether illustrated or not). For example, database 2106 can be an in-memory, conventional, or a database storing data consistent with the present disclosure. In some implementations, database 2106 can be a combination of two or more different database types (for example, hybrid in-memory and conventional databases) according to particular needs, desires, or particular implementations of the computer 2102 and the described functionality. Although illustrated as a single database 2106 in FIG. 21, two or more databases (of the same, different, or combination of types) can be used according to particular needs, desires, or particular implementations of the computer 2102 and the described functionality. While database 2106 is illustrated as an internal component of the computer 2102, in alternative implementations, database 2106 can be external to the computer 2102.

The computer 2102 also includes a memory 2107 that can hold data for the computer 2102 or a combination of components connected to the network 2130 (whether illustrated or not). Memory 2107 can store any data consistent with the present disclosure. In some implementations, memory 2107 can be a combination of two or more different types of memory (for example, a combination of semiconductor and magnetic storage) according to particular needs, desires, or particular implementations of the computer 2102 and the described functionality. Although illustrated as a single memory 2107 in FIG. 21, two or more memories 2107 (of the same, different, or combination of types) can be used according to particular needs, desires, or particular implementations of the computer 2102 and the described functionality. While memory 2107 is illustrated as an internal component of the computer 2102, in alternative implementations, memory 2107 can be external to the computer 2102.

The application 2108 can be an algorithmic software engine providing functionality according to particular needs, desires, or particular implementations of the computer 2102 and the described functionality. For example, application 2108 can serve as one or more components, modules, or applications. Further, although illustrated as a single application 2108, the application 2108 can be implemented as multiple applications 2108 on the computer 2102. In addition, although illustrated as internal to the computer 2102, in alternative implementations, the application 2108 can be external to the computer 2102.

The computer 2102 can also include a power supply 2114. The power supply 2114 can include a rechargeable or non-rechargeable battery that can be configured to be either user- or non-user-replaceable. In some implementations, the power supply 2114 can include power-conversion and management circuits, including recharging, standby, and power management functionalities. In some implementations, the power-supply 2114 can include a power plug to allow the computer 2102 to be plugged into a wall socket or a power source to, for example, power the computer 2102 or recharge a rechargeable battery.

There can be any number of computers 2102 associated with, or external to, a computer system containing computer 2102, with each computer 2102 communicating over network 2130. Further, the terms “client,” “user,” and other appropriate terminology can be used interchangeably, as appropriate, without departing from the scope of the present disclosure. Moreover, the present disclosure contemplates that many users can use one computer 2102 and one user can use multiple computers 2102.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A software widget comprising:
a geographic module specifying a first geographic space in which the software widget operates; and
a timeframe module specifying a first timeframe during which the software widget is accessible;
the software widget programmed to perform operations comprising:
performing, on a mobile device of a user, a function of the software widget comprising receiving from a user, after the user has obtained a copy of the software widget when in the first geographic space and during the first timeframe, a new configuration of the geographic module and of the timeframe module; and
performing the function within a new geographic space specified by the geographic module and during a new timeframe specified by the timeframe module.

2. The software widget of claim 1, wherein the copy of the software widget continues operating when the software widget is deleted.

3. The software widget of claim 1, wherein the operations further comprise:
obtaining a profile of the user; and
processing the profile to generate a personalized function; and
wherein performing the function comprises performing the personalized function.

4. The software widget of claim 1, wherein the software widget does not communicate location and time data to a third party.

5. The software widget of claim 1, wherein the software widget is derived from an editable template.

6. The software widget of claim 5, wherein the software widget continues operating when the editable template is deleted.

7. The software widget of claim 1, wherein the software widget is one of a collection of software widgets where each of the software widgets in the collection perform a function that is part of an event.

8. A method in a software widget comprising:
obtaining first data specifying a first geographic space in which the software widget operates;
obtaining second data specifying a first timeframe during which the software widget is accessible;
performing, on a mobile device of a user, a function of the software widget comprising receiving from a user, after the user has obtained a copy of the software widget when in the first geographic space and during the first timeframe, new location data specifying a second geographic space in which the software widget operates and new timeframe data specifying a second timeframe during which the software widget is accessible; and
performing the function within the second geographic space and during the second timeframe.

9. The method of claim 8, wherein the copy of the software widget continues operating when the software widget is deleted.

10. The method of claim 8, further comprising:
obtaining a profile of the user; and
processing the profile to generate a personalized function; and
wherein performing the function comprises performing the personalized function.

11. The method of claim 8, wherein the software widget does not communicate location and time data to a third party.

12. The method of claim 8, wherein the software widget is derived from an editable template.

13. The method of claim 12, wherein the software widget continues operating when the editable template is deleted.

14. The method of claim 8, wherein the software widget is one of a collection of software widgets where each of the software widgets in the collection perform a function that is part of an event.

15. A system comprising:
one or more computers and one or more storage devices on which are stored instructions that are operable, when executed by the one or more computers, to cause the one or more computers to perform operations comprising:
obtaining first data specifying a first geographic space in which a software widget operates;
obtaining second data specifying a first timeframe during which the software widget is accessible;
performing, on a mobile device of a user, a function of the software widget comprising receiving from a user, after the user has obtained a copy of the software widget when in the first geographic space and during the first timeframe, new location data specifying a second geographic space in which the software widget operates and new timeframe data specifying a second timeframe during which the software widget is accessible; and
performing the function within the second geographic space and during the second timeframe.

16. The system of claim 15, wherein the copy of the software widget continues operating when the software widget is deleted.

17. The system of claim 15, wherein the operations further comprise:
obtaining a profile of the user; and
processing the profile to generate a personalized function; and
wherein performing the function comprises performing the personalized function.

18. The system of claim 15, wherein the software widget does not communicate location and time data to a third party.

19. The system of claim 15, wherein the software widget is derived from an editable template.

20. The system of claim 19, wherein the software widget continues operating when the editable template is deleted.
